(19) United States
(12) Patent Application Publication
(10) Pub. No.: US 2010/0294228 A1
(43) Pub. Date: Nov. 25, 2010

(54) AIR INTAKE APPARATUS FOR INTERNAL COMBUSTION ENGINE

(76) Inventors: Yasutoshi Kameda, Toyota-shi (JP); Masato Ueshima, Muko-shi (JP); Masamichi Akagawa, Kariya-shi (JP)

Correspondence Address: KENYON & KENYON LLP, 1500 K STREET N.W., SUITE 700, WASHINGTON, DC, 20005, US

(21) Appl. No.: 12/294,996

(22) PCT Filed: Apr. 24, 2007
(86) PCT No.: PCT/JP2007/059352

§ 371 Date: Sep. 29, 2008

(30) Foreign Application Priority Data
Apr. 28, 2006 (JP) 2006-125634

(51) Int. Cl. F02M 35/10

(52) U.S. Cl. 123/184.56

(57) ABSTRACT

An air intake apparatus for an internal combustion engine is an apparatus introducing intake air into a combustion chamber, and includes an intake manifold attached to a cylinder head, and a cartridge fitted into the intake manifold. The cartridge includes a tube-like main body forming an air intake channel, a partition provided on the main body to separate the air intake channel into first and second passages, and an air intake control valve capable of reducing a channel cross sectional area of at least one of the first and second passages separated by the partition.

### TECHNICAL FIELD

The present invention relates to an air intake apparatus for an internal combustion engine, and particularly relates to an air intake apparatus for an internal combustion engine, having an air intake control valve.

### BACKGROUND ART

There has conventionally been known an air intake apparatus for an internal combustion engine, having an air intake control valve.

For example, Japanese Patent Laying-Open No. 2003-206761 (Patent Document 1) discloses an air charging apparatus capable of providing variable intake air flow rates, where a valve element is provided at each cylinder in an inline four-cylinder internal combustion engine.

Furthermore, the specification of German Patent Laying-Open No. 10108729 (Patent Document 2) discloses an internal combustion engine having a partition inserted into a cylinder head.

Furthermore, the specification of U.S. Pat. No. 5,273,014 (Patent Document 3) discloses that an insertion member, which is to be inserted into an air intake path of an internal combustion engine, has a tube-like portion and a partition portion.

When the air intake control valve is provided at the internal combustion engine, a partition is provided at an air intake path. However, in order to provide the partition at a cylinder head, the cylinder head must be processed for providing thereat an attachment guide portion such as a groove. Furthermore, it is necessary to modify the shape of the cylinder head depending on whether the air intake control valve is to be provided or not. Consequently, production cost increases.

From a viewpoint different from the foregoing, when the partition and the air intake control valve are separately attached to an intake manifold, assembly precision may deteriorate.

### DISCLOSURE OF THE INVENTION

An object of the present invention is to provide an air intake apparatus for an internal combustion engine, having an air intake control valve capable of generating a circling flow in intake air of the internal combustion engine while suppressing production cost increase and ensuring high assembly precision.

An air intake apparatus for an internal combustion engine according to the present invention is an air intake apparatus introducing intake air into a combustion chamber of the internal combustion engine, including: an intake manifold attached to a cylinder head of the internal combustion engine; and a fitting member fitted into the intake manifold. The fitting member includes a tube-like main body forming an air intake channel, a partition provided on the main body to separate the air intake channel into a plurality of air intake channels, and an air intake control valve capable of reducing a channel cross sectional area of at least one of the plurality of the air intake channels separated by the partition.

According to the above-described configuration, the partition and the air intake control valve can be provided on the air intake channel by inserting the fitting member into the intake manifold, and hence there is no need to provide at the cylinder head a guide portion for providing the partition. Accordingly, the number of process steps required for the cylinder head is reduced. Furthermore, it is possible to eliminate the need to modify the parts depending on whether the air intake control valve is to be provided or not. Additionally, the fitting member has the partition and the air intake control valve, so that the partition and the air intake control valve can integrally be attached to the intake manifold, which improves assembly precision of the partition and the air intake control valve. It is therefore possible to obtain an air intake apparatus for an internal combustion engine, having an air intake control valve capable of generating a circling flow in intake air of the internal combustion engine while suppressing cost increase and ensuring high assembly precision.

In the above-described air intake apparatus for the internal combustion engine, it is preferable that the internal combustion engine has a plurality of cylinders, and the fitting member is formed for each of the cylinders of the internal combustion engine.

As such, assembly precision of the partition and the air intake control valve is further improved. Additionally, the fitting member is more easily fitted into the intake manifold.

In the above-described air intake apparatus for the internal combustion engine, the main body and the partition in the fitting member are formed by integral molding, as an example.

Preferably, the above-descried air intake apparatus for the internal combustion engine further includes a shaft for rotatably driving the air intake control valve in the fitting member. Here, the internal combustion engine has a plurality of cylinders, and the shaft is provided to rotatably drive a plurality of the air intake control valves in a related manner, the plurality of the air intake control valves corresponding to the plurality of cylinders of the internal combustion engine, respectively.

The above-described configuration makes it possible to rotatably drive the plurality of air intake control valves with a simpler structure.

According to the present invention, as described above, it is possible to obtain an air intake apparatus for an internal combustion engine, having an air intake control valve capable of generating a circling flow in intake air of the internal combustion engine while suppressing cost increase and ensuring high assembly precision.

### BRIEF DESCRIPTION OF THE DRAWINGS

FIG. 1 is a general configuration diagram showing an air intake apparatus for an internal combustion engine according to an embodiment of the present invention.

FIG. 2 is a cross sectional view showing a fitting member in the air intake apparatus for the internal combustion engine shown in FIG. 1.

FIG. 3 is a perspective view showing the fitting member in the air intake apparatus for the internal combustion engine shown in FIG. 1.

FIG. 4 is a diagram showing how the fitting member shown in FIGS. 2 and 3 is being attached to an intake manifold.

FIG. 5 is a diagram showing the fitting member shown in FIGS. 2 and 3 is attached to the intake manifold.

### BEST MODES FOR CARRYING OUT THE INVENTION

An embodiment of an air intake apparatus for an internal combustion engine based on the present invention will hereinafter be described. Note that the same or corresponding parts are provided with the same reference characters, and the description thereof may not be repeated.

Note that, even when the number, amount or the like is referred to in the embodiment described below, the scope of the present invention is not necessarily limited thereto, unless otherwise particularly stated. Furthermore, each component is not necessarily essential to the present invention in the following embodiment, unless otherwise particularly stated. Moreover, if a plurality of embodiments exist in the following, an appropriate combination of characterizing portions of the respective embodiments has been contemplated from the beginning, unless otherwise particularly stated.

In the present specification, the “internal combustion engine” may be a gasoline engine or a diesel engine. An injector provided at the internal combustion engine may be an injector spraying fuel into the air intake channel, or an injector spraying fuel into the cylinder. Furthermore, both types of the injectors may be provided.

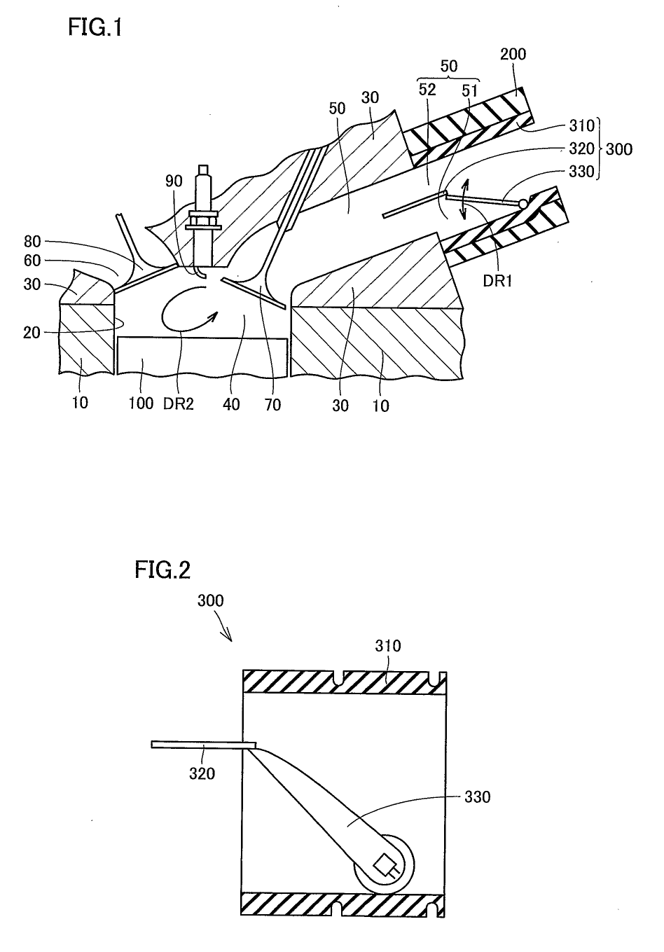

FIG. 1 is a general configuration diagram showing an air intake apparatus for an internal combustion engine according to an embodiment of the present invention. Referring to FIG. 1, a cylindrical cylinder 20 is formed in a cylinder block 10, and a pent roof-type combustion chamber 40 is provided at a cylinder head 30 covering a top of cylinder 20. An air intake channel 50 and an air exhaust channel 60 are formed such that they are connected to two inclined surfaces of combustion chamber 40, respectively. An end of air intake channel 50 is opened/closed by an air intake valve 70, while an end of air exhaust channel 60 is opened/closed by an air exhaust valve 80. An end portion of air intake channel 50 is bifurcated into two ends, and a pair of air intake valves 70 provided at each of the cylinders opens/closes the two ends, respectively. Similarly, a pair of air exhaust valves 80 is also provided at each of the cylinders. A plug 90 is placed at a central portion of combustion chamber 40 surrounded by these four valves. A piston 100 is placed in cylinder 20. Although a top face of piston 100 has a flat shape in the example in FIG. 1, the top face is configured as appropriate into a desired shape suitable for stratified explosion or the like.

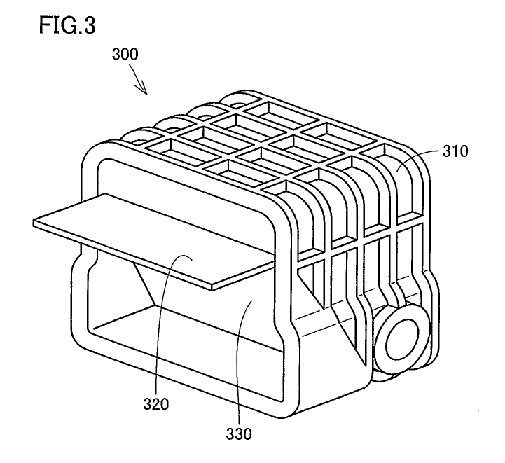

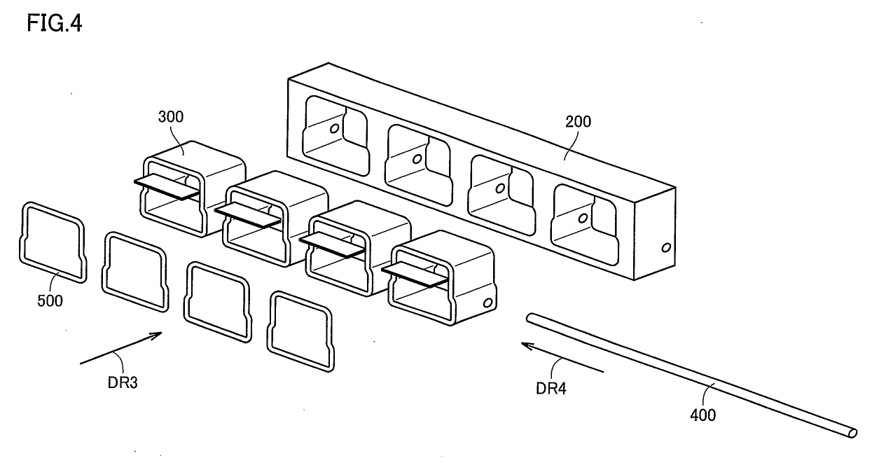

An intake manifold 200 is connected to cylinder head 30. Intake manifold 200 is composed of; for example, a resin such as nylon 6. A cartridge 300 is fitted into intake manifold 200. Cartridge 300 will be described with reference to FIG. 2 (cross sectional view) and FIG. 3 (perspective view) in addition to FIG. 1.

Cartridge 300 is configured to include a main body 310, a partition 320, and an air intake control valve 330. An air intake channel 50 is formed in main body 310. Air intake channel 50 is separated by partition 320 into first and second passages 51 and 52. Air intake control valve 330 turns in a direction of an arrow DR1 in FIG. 1 to adjust a channel cross sectional area of air intake channel 50.

Main body 310 and air intake control valve 330 are composed of, for example, a resin material (e.g. nylon 66 or the like) different from that of the intake manifold. As an example, main body 310 and air intake control valve 330 can be formed simultaneously by using the same mold. Alternatively, main body 310 and air intake control valve 330 may be composed of different materials, or main body 310 and air intake control valve 330 may be formed in different steps by using different molds. Furthermore, partition 320 may be composed of a resin through integral molding with main body 310, or may be composed through insert molding by inserting a metal plate when main body 310 is formed.

As shown in FIGS. 1-3, cartridge 300 is allowed to include partition 320 and air intake control valve 330, and cartridge 300, partition 320, and air intake control valve 330 are integrally attached to intake manifold 200. It is thereby possible to improve assembly precision of partition 320 and air intake control valve 330 to intake manifold 200. As a result, generation of an unexpected gap between partition 320 and air intake control valve 330 can be suppressed when, for example, air intake control valve 330 is totally closed.

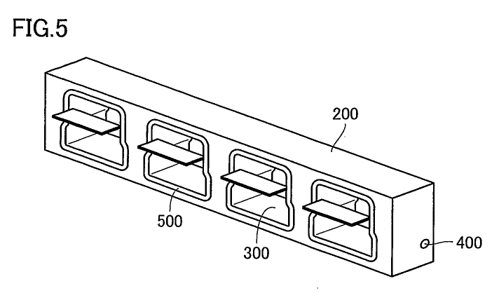

A step of attaching the partition and the air intake control valve to intake manifold 200 will now be described with reference to FIGS. 4 and 5. Referring to FIG. 4, cartridges 300, each having the partition and the air intake control valve, are fitted into intake manifold 200 such that one cartridge 300 corresponds to each of the cylinders. Subsequently, there is inserted a shaft 400 for driving the air intake control valves. At this time, shaft 400 is inserted into intake manifold 200 such that it pierces through the plurality of cartridges 300. A gasket 500 is then fitted thereinto. Through the step above, the plurality of cartridges 300 are fixed to intake manifold 200 as shown in FIG. 5.

In the air intake apparatus for the internal combustion engine according to present embodiment, partition 320 and air intake control valve 330 can be provided on the air intake channel by inserting cartridge 300 into intake manifold 200, so that there is no need to provide at cylinder head 30 a guide portion for providing the partition. Accordingly, it is possible to provide partition 320 and air intake control valve 330 without modifying the shape of cylinder head 30. Furthermore, cartridge 300 has partition 320 and air intake control valve 330, so that partition 320 and air intake control valve 330 can integrally be attached to intake manifold 200, which improves assembly precision of the partition 320 and the air intake control valve 330. As such, according to the present embodiment, it is possible to obtain an air intake apparatus for an internal combustion engine, having air intake control valve 330 capable of generating a circling flow (tumble flow) in intake air of the internal combustion engine while suppressing cost increase and ensuring high assembly precision.

Furthermore, one cartridge 300 is formed for each of the cylinders of the internal combustion engine, so that assembly precision of partition 320 and air intake control valve 330 is further improved. Moreover, cartridge 300 is more easily fitted into intake manifold 200.

Furthermore, shaft 400 is provided to rotatably drive, in a related manner, air intake control valves 330 in the plurality of cylinders of the internal combustion engine, so that the plurality of air intake control valves 330 can rotatably be driven with a simpler structure.

The above-described configuration is summarized as follows. The air intake apparatus for the internal combustion engine according to the present embodiment is an air intake apparatus introducing intake air into combustion chamber 40, and includes intake manifold 200 attached to cylinder head 30, and a cartridge 300 serving as a “fitting member” fitted into intake manifold 200. Cartridge 300 includes tube-like main body 310 forming air intake channel 50, a partition 320 provided on main body 310 and separating air intake channel 50 into first and second passages 51 and 52 serving as the “plurality of air intake channels”, and air intake control valve 330 capable of reducing a channel cross sectional area of at least one of first and second passages 51 and 52 separated by partition 320.

The embodiment of the present invention has been described. It should be understood, however, that the embodiment disclosed herein is illustrative and not limitative in all aspects. The scope of the present invention is shown by the claims, and intended to include all modifications within the equivalent meaning and scope of the claims.

### INDUSTRIAL APPLICABILITY

The present invention can be applied to an air intake apparatus for an internal combustion engine and others.

1. An air intake apparatus for an internal combustion engine, introducing intake air into a combustion chamber of the internal combustion engine, comprising:
an intake manifold attached to a cylinder head of said internal combustion engine; and
a fitting member fitted into said intake manifold,
said fitting member including
a tube-like main body forming an air intake channel,
a partition provided on said main body to separate the air intake channel into a plurality of air intake channels, and
an air intake control valve capable of reducing a channel cross sectional area of at least one of the plurality of said air intake channels separated by said partition.

2. The air intake apparatus for the internal combustion engine according to claim 1, wherein
said internal combustion engine has a plurality of cylinders, and
said fitting member is formed for each of the cylinders of said internal combustion engine.

3. The air intake apparatus for the internal combustion engine according to claim 1, wherein said main body and said partition in said fitting member are formed by integral molding.

4. The air intake apparatus for the internal combustion engine according to claim 1, further comprising a shaft for rotatably driving said air intake control valve in said fitting member, wherein
said internal combustion engine has a plurality of cylinders, and
said shaft is provided to rotatably drive a plurality of said air intake control valves in a related manner, the plurality of said air intake control valves corresponding to the plurality of cylinders of said internal combustion engine, respectively.
